(19) United States
(12) Patent Application Publication
(10) Pub. No.: US 2020/0367546 A1
(43) Pub. Date: Nov. 26, 2020

(54) STARCH BLENDS AND USES THEREOF

(71) Applicant: Corn Products Development, Inc., Westchester, IL (US)

(72) Inventors: Alicia Martin, Bridgewater, NJ (US); Brandon Roa, Bridgewater, NJ (US); Kyungsoo Woo, Bridgewater, NJ (US); Xin Yang, Bridgewater, NJ (US); Erhan Yildiz, Bridgewater, NJ (US)

(21) Appl. No.: 16/761,468

(22) PCT Filed: Oct. 30, 2018
(86) PCT No.: PCT/US18/58296

§ 371 Date: May 4, 2020

Related U.S. Application Data
(60) Provisional application No. 62/581,235, filed on Nov. 3, 2017.

(51) Int. Cl. A23L 29/212; A23L 23/00; A23L 13/00; A23L 9/10; A23C 9/154; C08L 3/02

(52) U.S. Cl. CPC A23L 29/212; A23L 23/00; A23L 13/06; A23V 2002/00; A23C 9/1544; C08L 3/02; A23L 9/10

(57) ABSTRACT

A starch blend includes 40-85% (w/w) of an unmodified amylose-containing starch and 15-60% (w/w) of a non-chemically inhibited starch. The starch blend, upon cooking in water has a high viscosity after one or more, two or more, three or more, four or more, or five or more freeze-thaw cycles. Such starch blend is useful in a variety of food and beverage compositions, particularly frozen sauces and gravies.

### CROSS-REFERENCE TO RELATED APPLICATIONS

This application claims the benefit of priority to U.S. Provisional Patent Application No. 62/581,235 filed on Nov. 3, 2017, the entire contents of which are incorporated herein by reference in their entirety for any and all purposes.

The present technology is generally related to starches and starch blends. More specifically it is related to starch blends that improve the texture and stability of comestibles that incorporate the starch blend.

Starches are used in the food industry to add texture to food products. It is the viscosifying properties of starches that are known to improve the texture of food products. The currently available starches, and particularly the amylose-containing starches, however, tend to gel upon cooking and cooling. Further, sauces and gravies, soups, creamers, salad dressings, and other liquid compositions prepared with amylose-containing starches become unstable upon freezing and thawing. As a result, there remains a need in the food industry for a starch that does not gel upon cooking and cooling and/or that is stable upon freezing and thawing.

In one aspect, a starch blend is provided that includes an unmodified amylose-containing starch and a non-chemically inhibited starch or non-chemically modified starch. Also disclosed herein are edible compositions comprising one or more starch blend described herein. Such starch blends address the gelling and/or stability problems associated with using the currently available starches.

These ranges may include 40-85% (w/w), 40-80% (w/w), 50-70% (w/w), 55-65% (w/w), or 50% (w/w) of the unmodified amylose-containing starch and 15-20% (w/w), 20-60% (w/w), 30-50% (w/w), 35-45% (w/w), or 50% (w/w) of the non-chemically inhibited or non-chemically modified starch. In some embodiments, the starch blends described herein are clean label starch blends.

One or more starch blend described herein has, upon cooking in water, a high viscosity after one or more, two or more, three or more, four or more, or five or more freeze-thaw cycles. One or more starch blend described herein has, upon cooking in water, a high viscosity after three or more freeze-thaw cycles. One or more starch blend described herein is useful in a variety of food and beverage compositions, particularly frozen sauces and gravies. Yet a further embodiment is directed to a method of preparing a composition comprising one or more viscosifying agent comprising one or more starch blend described herein and one or more other viscosifying agent, wherein the other viscosifying agent is at least partially replaced or replaced with 90% or less of one or more starch blend described herein.

In another aspect, a composition comprises 90-97% (w/w) of a fluid; 3-8% (w/w) of an unmodified amylose containing starch; and 0.5-2% (w/w) of a non-chemically inhibited starch or non-chemically modified starch. In some embodiments, the fluid is a milk product or water.

### BRIEF DESCRIPTION OF THE DRAWINGS

FIG. 1A is graph of the viscosity changes as a function of shear rate for the pudding formulations according to Example 7.

FIG. 1B is a series of photographs of the various formulations illustrating the behavior of the starch blends, according to Example 7.

FIG. 2 illustrates yield stress determination from flow curves for the pudding formulations according to Examples 8 and 9.

FIG. 3 is a graph of the viscosity changes as a function of shear rate for the pudding formulations according to Example 8.

FIGS. 4A and 4B are graphs of the viscosity changes as a function of shear rate for the pudding formulations according to Example 9.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The following terms are defined for clarity. Terms not defined should be accorded their ordinary meaning as used in the art and commonly understood by one of ordinary skill in the art.

The singular terms “a”, “an”, and “the” include the plural reference unless the context clearly indicates otherwise.

The term “amylose-containing” refers to a starch with at least 10% to less than 50% amylose (w/w) based upon the starch.

The term “gelatinization” refers to the process by which starch is cooked out and loses its granular structure. During gelatinization starch loses its birefringent property as well as any Maltese cross present in its native state.

The term “granular” refers to the structure of starch in which the starch is not cold water soluble (still at least partly crystalline) and exhibits birefringence and typically a Maltese cross under polarized light.

The term “non-chemical inhibition”, “non-chemically inhibited”, or “non-chemically modified” refers to a starch that functions as a chemically inhibited starch without being chemically modified.

The term “highly inhibited” refers to a starch that is inhibited to such a degree that it swells to a limited extent and shows a continuing rise in viscosity without attaining a peak.

The term “moderately inhibited” refers to a starch that is inhibited to such a degree that it exhibits a lower peak viscosity and a lower percentage breakdown in viscosity compared to the same starch that is not inhibited.

The term “native” refers to an unmodified starch as extracted from a plant source such as cereals, tubers, roots, legumes and fruits.

The term “starch” refers to starch and flour.

The term “unmodified” refers to a native starch or a native starch that has been physically modified. The term “unmodified” excludes a starch or flour that has been chemically or enzymatically modified.

In one aspect, disclosed herein is a starch blend comprising 40-80% (w/w) of an unmodified amylose-containing starch and 20-60% (w/w) of a non-chemically inhibited or non-chemically modified starch. Some embodiments are directed to one or more starch blends described herein, with the proviso that the unmodified amylose-containing starch is not a starch that that has been chemically or enzymatically modified. Surprisingly, despite the high level of amylose-containing starch, the one or more starch blends described herein, upon cooking in water, retain a high viscosity after one or more, two or more, or three or more freeze-thaw cycles. In one embodiment, the starch blend described herein is used in a variety of food and beverage compositions. In another embodiment, the starch blend described herein is used in frozen sauces and gravies. In still another embodiment, the starch blend described herein is a clean label starch blend.

In one embodiment, the unmodified amylose-containing starch is obtained from any amylose-containing starch source. In another embodiment, the non-chemically inhibited starch or non-chemically modified starch is obtained from any starch source. In yet another embodiment, the amylose-containing starch and/or the non-chemically inhibited starch or non-chemically modified starch is/are obtained from a starch source found in nature. In still another embodiment, the amylose-containing starch and/or the non-chemically inhibited starch or non-chemically modified starch is/are obtained from a plant obtained by standard breeding techniques, such as, for example, crossbreeding, translocation, inversion, transformation, insertion, irradiation, chemical or other induced mutation, any other method of gene or chromosome engineering to include variations thereof, and combinations thereof. In still yet another embodiment, amylose-containing starch and/or the non-chemically inhibited starch or non-chemically modified starch is/are obtained from a plant grown from induced mutations, which may be produced by known standard methods of mutation breeding.

In another embodiment, the amylose-containing and/or non-chemically inhibited starch or non-chemically modified starch is selected from cereals, tubers, roots, legumes, and fruits. The starch can be any variety, including, for example, without limitation, corn, potato, sweet potato, barley, wheat, rice, sago, amaranth, tapioca (cassava), arrowroot, canna, pea, lentil, fava (faba) bean, banana, oat, rye, triticale, or sorghum. In another embodiment, the non-chemically inhibited starch or non-chemically modified starch is any variety including, for example, low amylose (waxy) varieties. An amylose-containing variety is a starch that contains at least 10% to less than 50% amylose, at least about 15% to less than 50% amylose, or at least about 20% to less than 50% amylose, all by weight of the starch (w/w). A high amylose variety is a starch that contains at least 50% amylose, at least about 70% amylose, at least about 80% amylose, or at least about 90% amylose, all by weight of the starch (w/w). A low amylose or waxy variety is a starch that contains less than 10% amylose, less than about 5%, less than about 2%, or less than about 1% amylose, all by weight of the starch (w/w).

In one embodiment, each starch component described herein is in an intact granule form (granular), e.g. not completely gelatinized.

In one embodiment, the unmodified amylose-containing starch is a native starch. In another embodiment, the unmodified amylose-containing starch contains from at least 10% to less than 50% amylose, at least about 15% to less than 50% amylose, or at least about 20% to less than 50% amylose, all by weight of the starch (w/w). In a still further embodiment, the unmodified amylose-containing starch is a native amylose-containing starch selected from potato, rice, tapioca and corn. In an even further embodiment, the unmodified amylose-containing starch is a native amylose-containing starch that contains from about 10% to less than 50% amylose, at least about 15% to less than 50% amylose, or at least about 20% to less than 50% amylose, all by weight of the starch (w/w). In a yet further embodiment, the unmodified amylose-containing starch is a native amylose-containing starch that contains from about 10% to less than 50% amylose, at least about 15% to less than 50% amylose, or at least about 20% to less than 50% amylose, all by weight of the starch (w/w) and is selected from potato, rice, tapioca and corn. In another embodiment, the unmodified amylose-containing starch is a native amylose-containing potato starch that contains from about 10% to less than 50% amylose at least about 15% to less than 50% amylose, or at least about 20% to less than 50% amylose, all by weight of the starch (w/w).

In a further embodiment, the non-chemically inhibited starch or non-chemically modified starch is known in the art. Exemplary, non-chemically inhibited starches or non-chemically modified starches may be made by a variety of methods known in the art, including without limitation, by thermal inhibition or alcohol inhibition.

Thermal inhibition is known in the art as exemplified by, for example, U.S. Pat. Nos. 5,725,676; 5,932,017; 6,231,675; 6,451,121; 8,759,511; and 8,268,989. In one embodiment, the thermally inhibited starches prepared in accordance with a process comprising the steps of dehydrating the polysaccharide to anhydrous or substantially anhydrous (less than 1% moisture) and heating the anhydrous or substantially anhydrous starch until it functions similarly to a chemically modified or inhibited starch.

Alcohol inhibition is also known in the art as exemplified by, for example, US Patent Application No. 2013/309386. In one embodiment, the alcohol inhibited starch is prepared in accordance with a process comprising heating a starch in an alcoholic medium in the presence of a base or salt at a temperature of at least 35° C.

In another embodiment, the non-chemically inhibited starch or non-chemically modified starch is unmodified. In a further embodiment, the non-chemically inhibited starch or non-chemically modified starch is not further treated.

In yet a further embodiment, the non-chemically inhibited starch or non-chemically modified starch is a low amylose starch. In another embodiment, the non-chemically inhibited starch or non-chemically modified starch is a low amylose starch selected from waxy corn, waxy tapioca, waxy rice, and waxy potato. In a further embodiment, the non-chemically inhibited starch or non-chemically modified starch is a thermally inhibited starch. In yet a further embodiment, the degree to which the non-chemically inhibited starch or non-chemically modified starch is inhibited varies. For example, the degree of inhibition of the non-chemically inhibited starch or non-chemically modified starch is characterized by a variety of factors, such as, for example, the viscosity of a 5% dry solids starch slurry at a pH of 3 as it is heated to and then held at 95° C. In a still yet further embodiment, the non-chemically inhibited starch or non-chemically modified starch is highly inhibited. In an even further embodiment, the non-chemically inhibited starch or non-chemically modified starch is moderately inhibited.

In some embodiments, the non-chemically inhibited starch or non-chemically modified starch is a thermally inhibited waxy corn starch that is moderately inhibited. In still other embodiments, the non-chemically inhibited starch or non-chemically modified starch is a thermally inhibited waxy corn starch that is highly inhibited.

In a further embodiment, the unmodified amylose-containing starch; non-chemically inhibited starch or non-chemically modified starch; and/or one or more starch blend described herein is additionally processed, wherein said additional processing does not destroy the granular structure of said starch and said starch remains unmodified, e.g., said starch is not enzymatically or chemically modified. In some embodiments, the particle size of the unmodified amylose-containing starch; non-chemically inhibited starch or non-chemically modified starch; and/or one or more starch blends as described herein is adjusted by grinding, agglomerating, sieving, or combinations thereof.

In some embodiments, the unmodified amylose-containing starch; non-chemically inhibited starch or non-chemically modified starch; and/or the one or more starch blends described herein is used as-is or is first washed with excess water. In other embodiments, the unmodified amylose-containing starch; non-chemically inhibited starch or non-chemically modified starch; and/or the one or more starch blends described herein is purified by any method known in the art to remove off-flavors, odors, and/or colors that are native to the starch(es) or created during processing. Illustrative purification processes for treating starches are disclosed in, for example, EP554818. Exemplary alkali washing techniques are described in, for example, U.S. Pat. Nos. 4,477,480 and 5,187,272. In one embodiment, the unmodified amylose-containing starch; non-chemically inhibited starch or non-chemically modified starch; and/or one or more starch blend described herein is purified by post-heat treatment. The pH may also be adjusted using methods known in the art. In another embodiment, the pH of the one or more starch blends described herein is adjusted to between 5.5 and 8.0.

In one embodiment, a starch blend comprises 40-85% (w/w) of an unmodified amylose-containing starch and 15-60% (w/w) of a non-chemically inhibited or non-chemically modified starch. The starch blend may comprise from 40-80% (w/w) of an unmodified amylose-containing starch and 20-60% (w/w) of a non-chemically inhibited or non-chemically modified starch. In another embodiment, the starch blend comprises 50-70% (w/w) of an unmodified amylose-containing starch and 30-50% (w/w) of a non-chemically inhibited or non-chemically modified starch. In a further embodiment, the starch blend comprises 55-65% (w/w) of an unmodified amylose-containing starch and 35-45% (w/w) of a non-chemically inhibited or non-chemically modified starch. In an even further embodiment, the starch blend comprises about 50% (w/w) of an unmodified amylose-containing starch and about 50% (w/w) of a non-chemically inhibited or non-chemically modified starch.

Another embodiment is directed to the one or more starch blends described herein, with the proviso that said unmodified amylose-containing starch and said non-chemically inhibited or non-chemically modified starch are the only two starches in said blend. Yet another embodiment is directed to the one or more starch blends described herein, with the proviso that said unmodified amylose-containing starch and said non-chemically inhibited or non-chemically modified starch are the only viscosifiers in the blend.

One embodiment is directed to a test solution 1 comprising the one or more starch blend described herein, wherein the viscosity of said test solution 1 is stable at eating temperature after one, two, three, four, or five freeze-thaw cycles. Another embodiment is directed to a test solution 2 comprising one or more starch blend described herein, wherein the viscosity level of said solution at a cooling temperature after three, four, or five freeze-thaw cycles is at the same or comparable viscosity level as said solution after one or two freeze-thaw cycles. As used herein, the term “stable” refers to the viscosity of a freshly prepared sample compared to the viscosity after the freeze-cycles, where the viscosity a stable formulation/solution changes by no more than 5%. According to various embodiments, the viscosity of stable solution after a freeze-thaw cycle changes by no more than 5%, no more than 3%, no more than 2%, or no more than 1%. In some embodiments, the viscosity of the stable formulation/solution after the freeze-cycle changes by no more than 1%.

In one embodiment, the one or more test solutions 1 or 2 described herein is prepared by adding one or more starch blend described herein as it is to water at 4% solids and cooking the mixture at 95° C. for 20 minutes. In a further embodiment, the one or more test solutions 1 or 2 described herein is subjected to one or more, two or more, three or more, four or more, or five or more freeze-thaw cycles. In a still further embodiment, the freeze-thaw cycle comprises freezing at −18° C. for 16 hours and thawing at 25° C. for 8 hours.

In another embodiment, the one or more test solution 1 described herein has a viscosity of at least 20 Pa-s, 35 Pa-s, or 50 Pa-s at 65° C. and 0.1 rad/s when evaluated in accordance with the Test 1 methodology set forth in the Examples. In yet another embodiment, the one or more test solution 1 described herein has a viscosity of at least 2 Pa-s, 4 Pa-s, or 6 Pa-s at 65° C. and 1 rad/sec when evaluated in accordance with the Test 1 methodology set forth in the Examples. In still a further embodiment, the one or more test solution 1 described herein has a viscosity of at least 0.75 Pa-s or 1.0 Pa-s at 65° C. and 10 rad/sec when evaluated in accordance with the Test 1 methodology set forth in the Examples. In one embodiment, one or more starch blend described herein will not be significantly hydrolyzed, and, thus, will have substantially the same molecular weight as a blend of the native starches. In another embodiment, the average molecular weight of the one or more starch blends described herein will be at least 80%, at least 85%, at least 90%, or at least 95%, that of the native blend.

Yet a further embodiment is directed to a method of preparing a composition comprising one or more viscosifying agents, the composition comprising one or more starch blends as described herein and one or more other viscosifying agents, wherein the one or more other viscosifying agents are at least partially replaced with, or replaced with, 90% (w/w) or less of the one or more starch blends described herein. Yet a still further embodiment is directed to a method of preparing a composition comprising one or more viscosifying agents comprising one or more starch blends described herein and the one or more other viscosifying agents, wherein the one or more other viscosifying agents is at least partially replaced with, or replaced with, 90% or less of the one or more starch blends described herein and less than 10% of said viscosifying agent is the other viscosifying agent. Yet an even further embodiment is directed to a method of preparing a composition comprising one or more viscosifying agents comprising the one or more starch blends described herein and the one or more other viscosifying agents, wherein the one or more other viscosifying agents is replaced by an amount of the starch blend described herein that equals the amount of the other viscosifying agent being removed from said composition.

Another embodiment is directed to a food composition comprising one or more starch blends, as described herein. Yet another embodiment is directed to a liquid food composition comprising the one or more starch blends described herein. In one embodiment, a food composition is any ingestible product including without limitation, a food, a beverage, and nutraceutical. In another embodiment, the food composition is selected from beverages, smoothies, salad dressings, mayonnaises, sauces, gravies, soups, dairy products (such as, e.g. puddings, custards, yogurts, and sour creams), flans, pie fillings, fruit preps, jellies, jams, retorted products, and frozen or dry mixes of any of the foregoing. In still another embodiment, the one or more food compositions described herein is subjected to one or more, two or more, or three or more freeze-thaw cycles or and/or one or more, two or more, or three or more refrigeration-reheating cycles.

In another embodiment, the one or more food compositions described herein comprise the one or more starch blends described herein in an amount necessary to achieve the desired characteristics of said food composition. In a still further embodiment, the one or more food compositions described herein comprises at least about 1%, at least about 2.5%, or at least about 5%, by weight of the food composition, of the one or more starch blends as described herein. In yet still a further embodiment, the one or more food compositions described herein comprise no more than about 95%, no more than about 90%, or no more than about 80%, by weight of the product, of one or more starch blend described herein.

Another embodiment is directed to the one or more food compositions described herein, wherein said composition comprises at least one viscosifying agent and said viscosifying agent is at least partially replaced with one or more starch blends as described herein. Yet another embodiment is directed one or more food compositions as described herein, wherein said composition comprises at least one viscosifying agent, wherein said viscosifying agent comprises one or more starch blends as described herein, and at least one other viscosifying agent. In yet another embodiment, the other viscosifying agent is selected from chemically modified starches, flours, gums, and combinations thereof. A still further embodiment is directed to the one or more food compositions as described herein, wherein said composition comprises at least one viscosifying agent, wherein said viscosifying agent comprises at least one other viscosifying agent that is replaced by an amount of one or more starch blend described herein that equals the amount of the other viscosifying agent being removed from said composition. A still yet further embodiment is directed to one or more food composition described herein, wherein 90% (w/w) or less of the viscosifying agent is the one or more starch blend described herein and less than 10% of said viscosifying agent is the other viscosifying agent. Still another embodiment is directed to one or more food composition, wherein the only viscosifying agent contained in said composition is one or more starch blend described herein. Still another embodiment is directed to one or more food composition described herein, wherein said composition contains at least one additional edible ingredient. In another embodiment, the at least one additional edible ingredient is water.

In another aspect, the present invention is directed to starch blends of at least an instant starch or flour with a cook-up starch or flour to improve the texture stability of food systems and more particularly to impeding gelation. The blends of the instant starch or flour, more particularly a drum-dried amylose containing tapioca starch or flour, with the cook-up starch or flour, more particularly a thermally inhibited amylose containing tapioca starch, may increase the stability of a comestible using the cook-up starch or flour, more particularly a thermally inhibited amylose-containing tapioca starch or flour, by inhibiting gelation. The starch blends may be used to alter the rheology of comestibles, and more particularly to reduce shear thinning. The starch blends, more particularly a drum-dried thermally inhibited waxy corn, a drum-dried waxy corn, or a spray-dried waxy corn, with a cook-up starch or flour, more particularly a thermally inhibited waxy corn, can alter the flow properties of comestibles by increasing the flow behavior index, n, (i.e. less shear thinning or maintaining high viscosity at high shear rate).

In making food products, i.e. comestibles, such as frozen meals, refrigerated dairy and retorted soups, a starch or flour is added to improve the products rheological properties, textural properties, and stability of the final frozen or refrigerated food product. It has unexpectedly been found that the combination of a drum-dried amylose containing tapioca starch with thermally inhibited amylose containing tapioca starch provides improved refrigerator stability (reducing gelling) over thermally inhibited or native amylose containing tapioca starch alone.

In some embodiments, a composition is provided, the composition including 90-97% (w/w) of a fluid, 3-8% (w/w) of an inhibited amylose containing starch or flour; and 0.5-2% (w/w) of a non-inhibited starch or flour. The fluid may include a milk product or water. The inhibited amylose containing starch or flour may be any of those as described above, including, but not limited to a thermally inhibited tapioca starch or a thermally inhibited waxy corn starch. The non-inhibited amylose containing starch may be any of those as described above, including, but not limited to a drum-dried tapioca starch or flour, a drum-dried pre-gelled tapioca starch or flour, a spray-dried pre-gelled corn starch or flour, a drum-dried pre-gelled waxy corn starch or flour, or a spray-dried pre-gelled waxy corn starch or flour.

According to various embodiments, the composition may be a smoother texture after cooling to approximately 2-7° C. for one week, compared to a composition without the non-inhibited modified starch.

The present invention, thus generally described, will be understood more readily by reference to the following examples, which are provided by way of illustration and are not intended to be limiting of the present invention.

### EXAMPLES

The following examples are presented to further illustrate and explain the present invention and should not be taken as limiting in any regard. All percentages used are on a weight/weight basis.

### Example 1

### Assays

The following assays are standard assays used in the examples described below:

1A. Starch Test Solution (1 g batches). The starch ingredients are dry blended and then combined with distilled water in a Vorwerk Thermomix® (Vorwerk UK Limited, Berkshire, UK). The mixture is heated to 90° C. and held at 90° C. for 25 minutes while mixing in the Thermomix® at speed 2. At the end of 25 minutes, the mixture is promptly dispersed into 118.3 ml plastic jars and cooled in an ice bath below 40° C. The mixture is subsequently subjected to 1 or 3 freeze-thaw cycles. For each freeze-thaw cycle, one or more jar is placed in a non-cycling freezer between −10 and −20° C. for 16 hours, and at the end of 16 hours, the jar(s) are removed from the freezer and thawed at approximately 20-25° C. for 8 hours.

1B. Viscosity Measurements, Starch blends, and Equipment and Parameters.

Equipment and paramaters: Anton Paar MCR101 Rheometer and attachment CC24 cup/bob (24 mm diameter; available from Anton Paar GmbH, Graz, Austria).

Sample preparation (Starch Solution Formulations): Remove a frozen starch solution sample, place in a big cup, and then chop into small pieces. Heat the frozen sample in a 98° C. water bath for about 20 minutes until the sample reaches a temperature of 80° C. Load a first sample of the starch solution on the Rheometer and run Test 1 as set forth hereinbelow. Leave the rest of sample on the top of the water bath for about 20 minutes while Test 1 is completed. Load a second sample (about 75° C.) of the starch solution on the rheometer and run Test 2 as set forth hereinbelow.

Test 1: Texture Evaluation at Eating Temperature. Pre-set the rheometer to 65° C. Load the first sample of the starch solution on the rheometer and seal with silicon oil. Equilibrate the first sample at 65° C. Measure the viscosity at 0.1, 1 or 10 rad/s at 65° C.

Test 2: Texture Evaluation During Cooling. Pre-set the rheometer at 90° C. Load the second sample of the starch solution on the rheometer and seal with silicon oil. Equilibrate the second sample at 90° C. Measure viscosity at 10/s during cooldown from 90° C. to 22° C. at a cooldown rate of 3° C./minute and at 22° C. for five minutes.

Equipment and test used to measure the viscosity of food products: Sauce samples were heated in a boiling water bath with gentle hand stirring until samples reached 90° C., then viscosity was measured on a Brookfield viscometer at 85° C. (DV2T Digital Viscometer, AMETEK Brookfield, Middleboro, Mass.) with Spindle #3 at 20 RPM for 30 seconds

The following starch ingredients were used throughout the examples:

S1 is a thermally inhibited starch that is a moderately thermally inhibited, waxy corn starch commercially available from Ingredion Incorporated, Bridgewater, N.J., as NOVATION® 2600 starch.

S2 is a native potato starch that is commercially available from Ingredion Incorporated, Bridgewater, N.J., as PENPURE® 10 potato starch.

S3 is a native waxy potato starch that is commercially available from Ingredion Incorporated, Bridgewater, N.J., as PENPURE® 80 potato starch.

S4 is a native corn starch that is commercially available from Ingredion Incorporated, Bridgewater, N.J., as MELOJEL® cornstarch.

S5 is a native waxy corn starch that is commercially available from Ingredion Incorporated, Bridgewater, N.J., as AMIOCA™ cornstarch.

S6 is a native regular rice starch that is commercially available from Ingredion Incorporated, Bridgewater, N.J.

S7 is a native waxy rice starch that is commercially available from Ingredion Incorporated, Bridgewater, N.J.

S8 is a tapioca starch that is commercially available from Ingredion Incorporated, Bridgewater, N.J.

S9 is a thermally inhibited tapioca starch that is from a starch commercially available from Ingredion Incorporated, Bridgewater, N.J., as NOVATION® 3600 starch.

S10 is a drum-dried, pre-gelled tapioca flour commercially available from Ingredion Incorporated, Bridgewater, N.J., as HOMECRAFT™ Express 390 starch.

S11 is a spray dried, pre-gelled corn starch commercially available from Ingredion Incorporated, Bridgewater, N.J., as ULTRATEX™ IMF starch.

S12 is a thermally inhibited waxy corn starch commercially available from Ingredion Incorporated, Bridgewater, N.J., as NOVATION™ Prima 600 starch.

S13 is a drum-dried, pre-gelled waxy corn starch commercially available from Ingredion Incorporated, Bridgewater, N.J., as NATIONAL™ 298FG starch.

S14 is a spray-dried, pre-gelled waxy corn starch commercially available from Ingredion Incorporated, Bridgewater, N.J., as NOVATION™ Indulge 2930 starch.

### Example 2

### Starch Blends and Viscosities

The viscosities of a number of starch solutions were tested using Test 1 or Test 2, and the results of the tests are set forth below in Table 2. The formulations of the starch solutions are set forth below in Table 1, wherein TI is the acronym for “thermally inhibited”. “Test Solution 1” as used herein means a starch solution formulation as described hereinbelow in Table 1 that is tested in accordance with Test 1 as set forth hereinabove. “Test Solution 2” as used herein means a starch solution formulation as described hereinbelow in Table 1 that is tested in accordance with Test 2 set forth hereinabove.

TABLE 1
Starch Solution Formulations

| | 70% S1 + | 70% S1 + | 70% S1 + | 70% S1 + | 70% S1 + | 70% S1 + |
|---|---|---|---|---|---|---|
| Ingredient | 30% S2 | 30% S3 | 30% S4 | 30% S5 | 30% S6 | 30% S7 |
| Water | 94.5 | 94.4 | 94.6 | 94.6 | 94.6 | 94.6 |
| Salt | 1 | 1 | 1 | 1 | 1 | 1 |
| S1 | 3.1 | 3.1 | 3.1 | 3.1 | 3.1 | 3.1 |
| S2 | 1.4 | | | | | |
| S3 | | 1.5 | | | | |
| S4 | | | 1.3 | | | |
| S5 | | | | 1.3 | | |
| S6 | | | | | 1.3 | |
| S7 | | | | | | 1.3 |
| Total (%) | 100 | 100 | 100 | 100 | 100 | 100 |
| Starch Solids (%) | 4.00 | 4.00 | 4.00 | 4.00 | 4.00 | 4.00 |
| | 30% S1 + | 30% S1 + | 30% S1 + | 30% S1 + | 30% S1 + | 30% S1 + |
| Ingredient | 70% S2 | 70% S3 | 70% S4 | 70% S5 | 70% S6 | 70% S7 |
| Water | 94.6 | 94.3 | 94.6 | 94.6 | 94.6 | 94.6 |
| Salt | 1 | 1 | 1 | 1 | 1 | 1 |
| S1 | 1.3 | 1.3 | 1.3 | 1.3 | 1.3 | 1.3 |
| S2 | 3.1 | | | | | |
| S3 | | 3.4 | | | | |
| S4 | | | 3.1 | | | |
| S5 | | | | 3.1 | | |
| S6 | | | | | 3.1 | |
| S7 | | | | | | 3.1 |
| Total (%) | 100 | 100 | 100 | 100 | 100 | 100 |
| Starch Solids (%) | 4.00 | 4.00 | 4.00 | 4.00 | 4.00 | 4.00 |

TABLE 2
Starch Solution Viscosities

| | Viscosity at Constant Temperature (65° C.) | | | Viscosity at Constant Shear Rate (10 rad/sec) | | | |
|---|---|---|---|---|---|---|---|
| | with Variable Shear Rate TEST 1 | | | with Variable Temperature TEST 2 | | | |
| | Viscosity | Viscosity | Viscosity | Viscosity | Viscosity | Viscosity | Viscosity |
| | at 0.1 rad/s | at 1 rad/s | at 10 rad/s | at 90° C. | at 60° C. | at 45° C. | at 27° C. |
| Sample | [Pa · s] | [Pa · s] | [Pa · s] | [Pa · s] | [Pa · s] | [Pa · s] | [Pa · s] |
| 70% S1 + 30% S2 | 25.2 | 2.9 | 0.4 | 0.6 | 0.7 | 0.8 | 1.0 |
| 70% S1 + 30% S3 | 7.1 | 1.6 | 0.5 | 0.5 | 0.5 | 0.6 | 0.8 |
| 30% S1 + 70% S2 | 49.1 | 6.8 | 1.3 | 1.0 | 1.2 | 1.3 | 1.5 |
| 30% S1 + 70% S3 | 1.9 | 0.8 | 0.3 | 0.3 | 0.3 | 0.4 | 0.6 |
| 70% S1 + 30% S4 | 32.6 | 4.1 | 0.8 | 0.7 | 0.9 | 1.0 | 1.2 |
| 70% S1 + 30% S5 | 5.9 | 1.3 | 0.4 | 0.3 | 0.4 | 0.5 | 0.6 |
| 30% S1 + 70% S4 | 69.6 | 8.3 | 1.0 | 1.1 | 1.1 | 1.2 | 1.3 |
| 30% S1 + 70% S5 | 0.9 | 0.5 | 0.1 | 0.2 | 0.2 | 0.3 | 0.4 |
| 70% S1 + 30% S6 | 36.6 | 5.6 | 0.9 | 0.6 | 0.8 | 1.0 | 1.2 |
| 70% S1 + 30% S7 | 11.2 | 1.9 | 0.4 | 0.4 | 0.5 | 0.6 | 0.7 |
| 30% S1 + 70% S6 | 50.6 | 7.8 | 1.2 | 0.7 | 0.8 | 0.9 | 1.1 |
| 30% S1 + 70% S7 | 9.3 | 1.9 | 0.6 | 0.5 | 0.6 | 0.8 | 1.0 |

The Test 1 data in Table 2 demonstrates that samples formulated with thermally inhibited starch and native amylose containing starch have a higher viscosity than their counterpart formulations containing native waxy starch over a range of shear rates.

The Test 2 data in Table 2 demonstrates that samples formulated with thermally inhibited starch and native amylose containing starch have a higher viscosity than their counterpart formulations containing native waxy starch over a range of temperatures typical used in heated food applications.

### Example 3

### Use of Starch Blends in Beef Gravy

The viscosities of several beef gravy formulations were measured and the results of these measurements are set forth in Table 3.

TABLE 3
Beef Gravy Formulations (ingredients set forth as wt %)

| | Beef | Beef | Beef | Beef | Beef | Beef |
|---|---|---|---|---|---|---|
| Ingredient | Gravy 1 | Gravy 2 | Gravy 3 | Gravy 4 | Gravy 5 | Gravy 6 |
| Seasoned | 90.69 | 90.69 | 90.69 | 90.69 | 90.69 | 90.69 |
| Beef Broth | | | | | | |
| S1 | 1.63 | 1.63 | 1.63 | 1.63 | 1.63 | 1.63 |
| S6 | 1.63 | | | | | |
| S7 | | 1.63 | | | | |
| S4 | | | 1.63 | | | |
| S5 | | | | 1.63 | | |
| S2 | | | | | 1.63 | |
| S3 | | | | | | 1.63 |
| Flour | 1.00 | 1.00 | 1.00 | 1.00 | 1.00 | 1.00 |
| Salt | 0.75 | 0.75 | 0.75 | 0.75 | 0.75 | 0.75 |
| Vegetable | 4.30 | 4.30 | 4.30 | 4.30 | 4.30 | 4.30 |
| Shortening | | | | | | |
| Total | 100.00 | 100.00 | 100.00 | 100.00 | 100.00 | 100.00 |

The gravy was prepared by combining the broth and vegetable shortening. The dry ingredients were mixed and then added using a Vorwerk Thermomix® (Vorwerk UK Limited, Berkshire, UK). The mixture was heated to 90° C. and held at such temperature for 20 minutes. The Vorwerk Thermomix® (Vorwerk UK Limited, Berkshire, UK) was turned off, and the gravy was filled into jars and cooled to 25° C. in an ice bath.

Brookfield viscosity was measured after one and three freeze-thaw (“F/T”) cycles for each sample. The results are shown below in Table 4.

TABLE 4
Beef Gravy Viscosities

Brookfield Viscosity (cP)

| Food Product | 1 F/T cycle | 3 F/T cycles |
|---|---|---|
| Beef Gravy 1: S1 + S6 | 1260 | 1195 |
| Beef Gravy 2: S1 + S7 | 1295 | 1043 |
| Beef Gravy 3: S1 + S4 | 1653 | 1798 |
| Beef Gravy 4: S1 + S5 | 923 | 805 |
| Beef Gravy 5: S1 + S2 | 1623 | 1278 |
| Beef Gravy 6: S1 + S3 | 805 | 610 |

The data in Table 4 demonstrates that samples formulated with a thermally inhibited starch and a native amylose containing starch are higher in viscosity than their counterpart formulations containing native waxy starch after three freeze-thaw cycles.

### Example 4 (Prophetic)

### Use of Starch Blends in a Tomato Sauce

Several tomato sauce formulations containing one or more starch blends described herein are set forth below in Table 5.

TABLE 5
Tomato sauce formulations (ingredients set forth in wt %)

| | Tomato | Tomato | Tomato | Tomato |
|---|---|---|---|---|
| Ingredient | Sauce 1 | Sauce 2 | Sauce 3 | Sauce 4 |
| Water | 62.95 | 62.95 | 62.95 | 62.95 |
| Tomato paste | 30.00 | 30.00 | 30.00 | 30.00 |
| S1 | 1.50 | 1.50 | 1.50 | 1.50 |
| S6 | 1.50 | | | |
| S4 | | 1.50 | | |
| S8 | | | 1.50 | |
| S2 | | | | 1.50 |
| Salt | 1.10 | 1.10 | 1.10 | 1.10 |
| Sugar | 1.00 | 1.00 | 1.00 | 1.00 |
| Herb seasoning | 1.45 | 1.45 | 1.45 | 1.45 |
| blend, dried | | | | |
| Soy oil | 0.50 | 0.50 | 0.50 | 0.50 |
| Total | 100.00 | 100.00 | 100.00 | 100.00 |

The tomato sauce is prepared by combining the water, oil, and tomato paste, then mixing until smooth. The starch, herb seasoning blend, salt, and sugar are dry blended and whisked into the water/oil/tomato paste mixture. The mixture is added to the Vorwerk Thermomix® (Vorwerk UK Limited, Berkshire, UK) and heated to 90° C., then held at such temperature for 20 minutes. The Vorwerk Thermomix® (Vorwerk UK Limited, Berkshire, UK) is then turned off, and the tomato sauce is filled into jars and cooled to 25° C. in an ice bath.

### Example 5

### Dairy Model System Formulas

A starch blend comprising S9 and S10 improved the stability of the dairy formulation set forth in Table 6 hereinbelow under refrigerated storage condition of approximately 2-7° C.

TABLE 6
Dairy model system formula

| Ingredients | Formula 1 (wt %) | Formula 3 (wt %) |
|---|---|---|
| Non-fat milk | 95.0 | 94.0 |
| S9 | 5.0 | 5.0 |
| S10 | | 1.0 |

The dairy formulations set forth in Table 6 were prepared by first weighing the starch(es) and then slurrying the starches into the milk. This mixture is then premixed in a Thermomix (TM5-4) for five minutes at room temperature at speed 2. The temperature was then adjusted to 90.6° C. and held for 25 minutes. The mixture was subsequently dispensed into jars and stored under refrigeration at approximately 2-7° C.

The samples were visually evaluated over time and the formulation containing the starch blend comprising S9 and S10 exhibited improved stability at both 24 hours and 6 weeks aging. The use of S9 alone resulted in a very firm gel, which on stirring remained very lumpy. The starch blend comprising S9 and S10, however, provided a soft-set product having a smooth texture upon stirring.

### Example 6

### Water Model System Formulas

The same starch combination as in Example 5 was also tested in a simple starch/flour and water system. In starch and water, improved stability was also observed with the addition of a starch blend comprising S9 and S10.

TABLE 7
Water Model System Formula

| Ingredients | Formula 9 (wt %) | Formula 10 (wt %) |
|---|---|---|
| Water | 95.0 | 94.0 |
| S9 | 5.0 | 5.0 |
| S10 | | 1.0 |

A starch blend comprising S9 and S10 provided a food composition with significantly improved texture—no gelling or syneresis, and no graininess. This starch blend may be used to produce a sauce, gravy or soup that has the appearance and eating quality that consumers desire after being stored under refrigeration (e.g. about 2-7° C.).

### Example 7

### Pudding Application

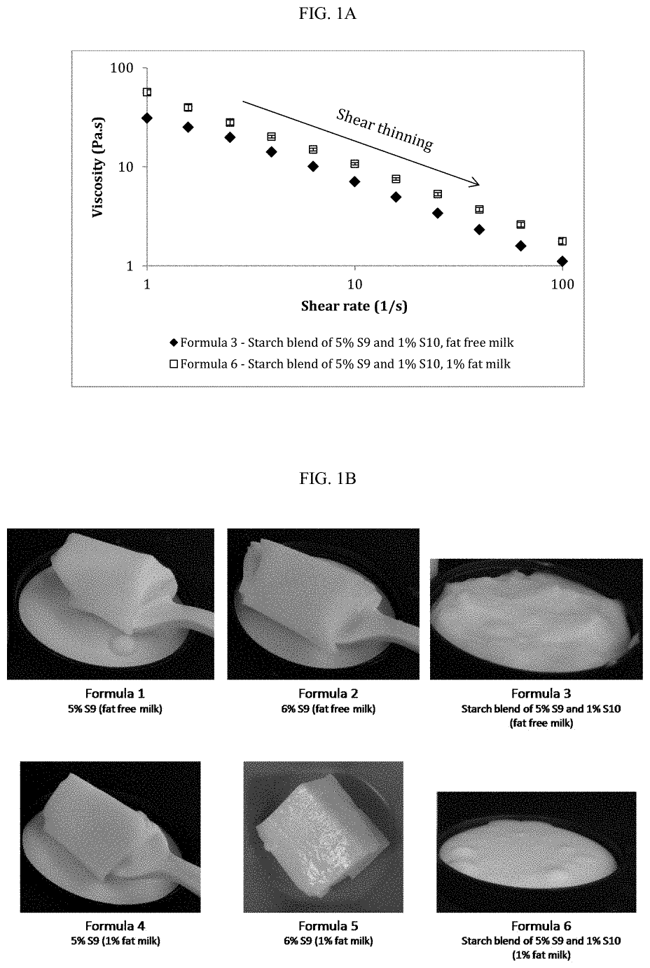

This example illustrates the improvement of pudding stability using a starch blend comprising S9 and S10. As demonstrated in FIG. 1B, the pudding made with 5% or 6% S9 formed a gel after being stored under refrigerated conditions for 2 weeks. As further demonstrated in FIG. 1B, the pudding made with a starch blend comprising 5% S9 and 1% S10 had a smooth texture after being stored under refrigerated conditions for 2 weeks. This smooth texture was observed in pudding made with fat free milk and 1% fat milk. As demonstrated in FIG. 1A, the viscosities of pudding formulations 1-6 set forth hereinbelow in Table 8 were measured and showed shear thinning properties, wherein the viscosity of the pudding formulations decreased as shearing rate increased.

TABLE 8
Pudding formulations (amounts are in wt %)

| | Formula | Formula | Formula | Formula | Formula | Formula |
|---|---|---|---|---|---|---|
| Ingredient | 1 | 2 | 3 | 4 | 5 | 6 |
| Fat free milk | 95.00 | 94.00 | 94.00 | | | |
| 1% fat milk | | | | 95.00 | 94.00 | 94.00 |
| S9 | 5.00 | 6.00 | 5.00 | 5.00 | 6.00 | 5.00 |
| S10 | | | 1.00 | | | 1.00 |
| Total | 100.00 | 100.00 | 100.00 | 100.00 | 100.00 | 100.00 |

### Example 8

### Pudding Texture

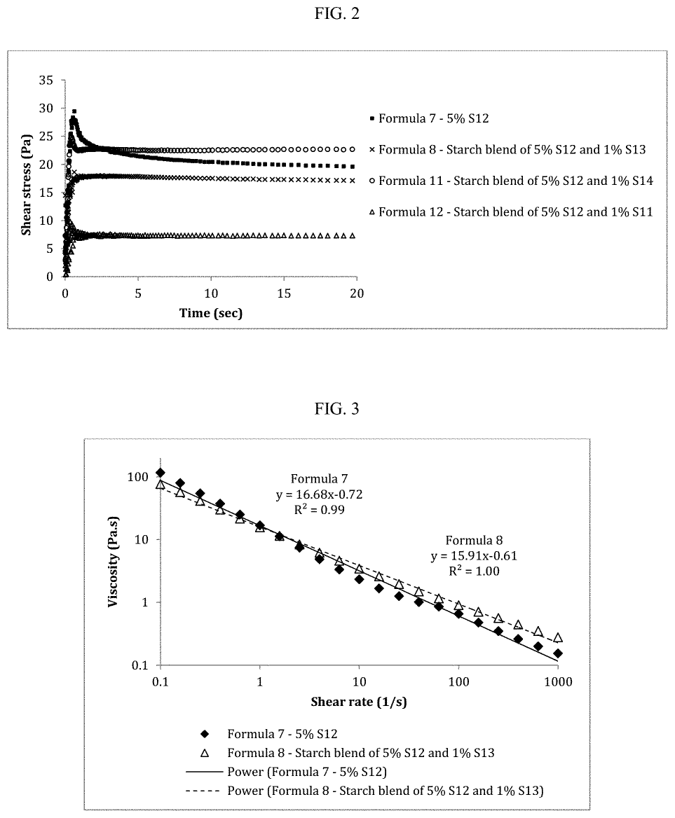

This example demonstrates how a starch blend, specifically a drum-dried waxy corn, with a cook-up starch, specifically thermally inhibited waxy corn, can be used to change rheology properties of a food system. Addition of S13 can reduce yield stress (FIG. 2) and change the flow curve shape of pudding made of 5% S12 by reducing curve slope of viscosity versus shear rate on a log-log scale (FIG. 3).

Power law model (Eq. 1: σ=Kγⁿ or η=Kγⁿ⁻¹) was used to describe flowing property of materials, where σ [Pa] is shear stress, η [Pa·s] is the apparent viscosity, γ [1/s] is shear rate, K [Pa·s] is the flow consistency index, and n is the flow behavior index. For shear thinning material, the flow behavior index is typically a value between 0 and 1, where a higher value indicates less shear thinning. As illustrated in Table 10, addition of S13 led to higher flow behavior index, suggesting less shear thinning.

TABLE 9
Pudding Formulations (amounts are in wt %)

| Ingredient | Formula 7 | Formula 8 |
|---|---|---|
| Fat free milk | 95.00 | 94.00 |
| S12 | 5.00 | 5.00 |
| S13 | | 1.00 |
| Total | 100.00 | 100.00 |

TABLE 10
Flow Property of Puddings

| | | Flow Consistency | Flow behavior |
|---|---|---|---|
| Formula | Starch | Index K [Pa · s] | index n |
| Formula 7 | 5% S12 | 16.7 | 0.28 |
| Formula 8 | 5% S12 + 1% S13 | 15.9 | 0.39 |

### Example 9

### Food Systems

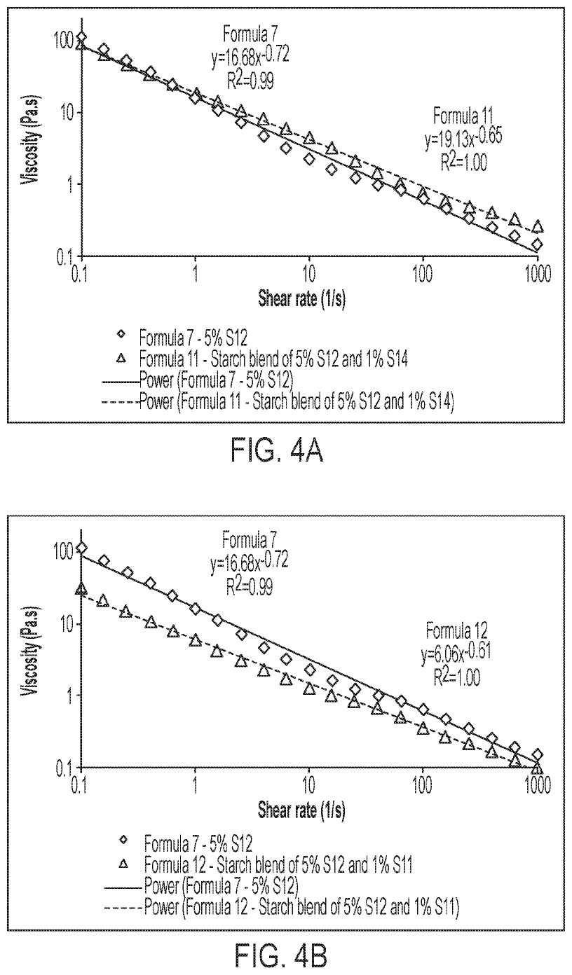

This example demonstrates that the starch blends described herein, specifically a drum-dried waxy corn starch or a spray-dried waxy corn starch, with a cook-up starch, specifically a thermally-inhibited waxy corn, can be used to change the rheology property of food systems. Addition of S14 or S11 has the same effects as S13 and can reduce yield stress (FIG. 2) and change flow curve shapes (FIGS. 4A and 4B) with increasing flow behavior index, n, (Table 12) of pudding made of 5% S12.

TABLE 11
Pudding Formulations (amounts are in wt %)

| Ingredient | Formula 7 | Formula 8 | Formula 11 | Formula 12 |
|---|---|---|---|---|
| Fat free milk | 95.00 | 94.00 | 94.00 | 94.00 |
| S12 | 5.00 | 5.00 | 5.00 | 5.00 |
| S13 | | 1.00 | | |
| S14 | | | 1.00 | |
| S11 | | | | 1.00 |
| Total | 100.00 | 100.00 | 100.00 | 100.00 |

TABLE 12
Flow Properties of the Pudding Formulations from Table 11

| | | Flow Consistency | Flow behavior |
|---|---|---|---|
| Formula | Starch | Index K [Pa · s] | index n |
| Formula 7 | 5% S12 | 16.7 | 0.28 |
| Formula 11 | 5% S12 + 1% S13 | 19.1 | 0.35 |
| Formula 12 | 5% S12 + 1% S11 | 6.1 | 0.39 |

The following embodiments are presented to further illustrate and explain the present invention and are not intended to be limiting in any regard.

Para. A. A starch blend comprising: 40-80% (w/w), 50-70% (w/w), 55-65% (w/w), or 50% (w/w) of an unmodified amylose containing starch, and 20-60% (w/w), 30-50% (w/w), 35-45% (w/w), or 50% (w/w) of a non-chemically inhibited starch or non-chemically modified starch.

Para. B. The starch blend according to Para. A, wherein a test solution 1 comprising said starch blend has a viscosity of at least 2 Pa-s, 4 Pa-S, or 6 Pa-s at 65° C. with a 1 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

Para. C. The starch blend according to Para. A or B, wherein a test solution 1 comprising said starch blend has a viscosity of at least 20 Pa-s, 35 Pa-S, or 50 Pa-S at 65° C. with a 0.1 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

Para. D. The starch blend according to any one of Paras. A-C, wherein a test solution 1 comprising said starch blend has a viscosity of at least 0.6 Pa-s, 0.8 Pa-s, or 1.0 Pa-S at 90° C. with a 10 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

Para. E. The starch blend according to any one of Paras. A-D, wherein a test solution 2 comprising said starch blend has a viscosity of at least 0.6 Pa-s, 0.8 Pa-s, or 1.0 Pa-s at 90° C. and 10 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

Para. F. The starch blend according to any one of Paras. A-E, wherein a test solution 2 comprising said starch blend has a viscosity of at least 0.7 Pa-s, 0.8 Pa-s, or 1.0 Pa-s at 60° C. and 10 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

Para. G. The starch blend according to any one of Paras. B-F, wherein the viscosity at eating temperature of said solution is at a level after four or five freeze-thaw cycles that is the same or comparable to the viscosity after zero, one, two or three freeze-thaw cycles.

Para. H. The starch blend according to any one of Paras. B-G, wherein the viscosity of said solution is stable at eating temperature after one, two, three, four or five freeze-thaw cycles.

Para. I. The starch blend according to any one of Paras. B-H, wherein the viscosity level of said solution at a cooling temperature after three, four, or five freeze-thaw cycles is at the same or comparable viscosity level as said solution after one or two freeze-thaw cycles.

Para. J. The starch blend according to any one of Paras. B-I, wherein prior to being subjected to one or more, two or more, three or more, four or more, or five or more freeze-thaw cycles said solution is prepared by adding said starch blend as it is to water at 4% solids and cooking at 95° C. for 20 minutes.

Para. K. The starch blend according to any one of Paras. B-J, wherein said solution is subject to two or more, three or more, or three freeze-thaw cycles.

Para. L. The starch blend according to any one of Paras. A-K, wherein the unmodified amylose containing starch is in granule form and the non-chemically inhibited starch is in granule form.

Para. M. The starch blend according to any one of Paras. A-L, wherein: (i) the unmodified amylose containing starch is a native starch; (ii) the unmodified amylose-containing starch contains from at least 10% to less than 50% amylose, at least about 15% to less than 50% amylose, or at least about 20% to less than 50% amylose, all by weight of the starch (w/w); (iii) the unmodified amylose-containing starch is a native amylose-containing starch that contains from about 10% to less than 50% amylose, at least about 15% to less than 50% amylose, or at least about 20% to less than 50% amylose, all by weight of the starch (w/w); or (iv) the unmodified amylose containing starch is a native amylose-containing potato starch that contains from about 10% to less than 50% amylose, at least about 15% to less than 50% amylose, or at least about 20% to less than 50% amylose, all by weight of the starch (w/w).

Para. N. The starch blend according to any one of Paras. A-M, wherein the unmodified amylose containing starch is selected from potato, rice, tapioca and corn.

Para. O. The starch blend according to any one of Paras. A-N, wherein the non-chemically inhibited starch or non-chemically modified starch is a low amylose starch or a starch that contains less than 10% amylose, less than about 5%, less than about 2%, or less than about 1% amylose, all by weight of the starch (w/w).

Para. P. The starch blend according to any one of Paras. A-O, wherein the non-chemically inhibited starch or non-chemically modified starch is selected from waxy corn, waxy tapioca, waxy rice, and waxy potato.

Para. Q. The starch blend according to any one of Paras. A-P, wherein the non-chemically inhibited starch or non-chemically modified starch is a thermally inhibited starch.

Para. R. The starch blend according to any one of Paras. A-Q, wherein the non-chemically inhibited starch or non-chemically modified starch is a moderately inhibited starch.

Para. S. The starch blend according to any one of Paras. A-R, wherein the non-chemically inhibited starch or non-chemically modified starch is a thermally inhibited, waxy corn starch that is moderately inhibited.

Para. T. A food composition comprising the starch blend according to any one of Paras. A-S, wherein said food composition is optionally liquid.

Para. U. The food composition according to embodiment 20, wherein said food composition comprises at least one additional edible ingredient.

Para. V. The food composition according to Para. T or U, wherein said composition comprises at least one viscosifying agent, wherein: (i) said viscosifying agent comprises the starch blend according to any preceding claim and at least one other viscosifying agent; (ii) said viscosifying agent comprises the starch blend according to any preceding claim and at least one other viscosifying agent, (ii) 90% (w/w) or less of said viscosifying agent is the starch blend according to any preceding claim and less than 10% of said viscosifying agent is the other viscosifying agent, (iii) the viscosifying agent is the starch blend according to any preceding claim, or (iv) the viscosifying agent is the starch blend according to any preceding claim, with the proviso that the only viscosifying agent contained in said composition is the starch blend according to any preceding claim.

Para. W. The food composition according to any one Paras. T-V, wherein said food composition comprises at least about 1%, at least about 2.5%, or at least about 5%, by weight of the food composition, of the starch blend according to any preceding claim.

Para. X. The food composition according to any one of Paras. T-W, wherein said food composition is selected from beverages, smoothies, salad dressings, mayonnaises, sauces, gravies, soups, dairy products (such as, e.g. puddings, custards, yogurts, and sour creams), flans, pie fillings, fruit preps, jellies, jams, retorted products, and frozen or dry mixes of any of the foregoing.

Para. Y. A method for preparing a food composition, wherein said composition comprises at least one viscosifying agent, wherein said viscosifying agent comprises the starch blend according to any one of Paras. A-S and at least one other viscosifying agent and said other viscosifying agent is at least partially replaced or replaced with 90% or less of the starch blend according to any one of Paras. A-S.

Para. AA. A composition comprising: 90-97% (w/w) of a fluid; 3-8% (w/w) of an inhibited amylose containing starch; and 0.5-2% (w/w) of a non-inhibited amylose containing starch.

Para. AB. The composition of Para. AA, wherein the fluid comprises a milk product or water.

Para. AC. The composition of Para. AA or AB, wherein the non-inhibited amylose containing starch or non-chemically modified starch is selected from waxy corn, waxy tapioca, waxy rice, and waxy potato.

Para. AD. The composition of any one of Paras. AA-AC, wherein the non-chemically inhibited starch or non-chemically modified starch is a thermally inhibited starch.

Para. AE. The composition of any one of Paras. AA-AD, wherein the non-chemically inhibited starch or non-chemically modified starch is a moderately inhibited starch.

Para. AF. The composition of any one of Paras. AA-AE, wherein the non-chemically inhibited starch or non-chemically modified starch is a thermally inhibited, waxy corn starch that is moderately inhibited.

Para. AG. The composition of any one of Paras. AA-AF, wherein the composition exhibits a smoother texture after cooling to approximately 2-7° C. for one week, compared to a composition without the non-inhibited modified starch.

A method of preparing a composition, wherein said composition comprises one or more viscosifying agent, wherein said viscosifying agent comprises a starch blend according to any one of embodiments 1 to 19 and one or more other viscosifying agent, wherein said other viscosifying agent is at least partially replaced or replaced with 90% or less of the starch blend according to any one of embodiments 1 to 19.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-31. (canceled)

32. A starch blend comprising:
40-85% (w/w) of an unmodified amylose containing starch; and
15-60% (w/w) of a non-chemically inhibited starch or non-chemically modified starch.

33. The starch blend according to claim 32 comprising 50-70% (w/w) of an unmodified amylose containing starch, and 30-50% (w/w) of a non-chemically inhibited starch or non-chemically modified starch.

34. The starch blend according to claim 32, wherein a test solution 1 comprising said starch blend has a viscosity of at least 2 Pa-s, 4 Pa-S, or 6 Pa-s at 65° C. with a 1 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

35. The starch blend according to claim 32, wherein a test solution 2 comprising said starch blend has a viscosity of at least 0.6 Pa-s, 0.8 Pa-s, or 1.0 Pa-s at 90° C. and 10 rad/sec shear rate when said solution is subjected to one or more, two or more, three or more, four or more, or five or more freeze-thaw cycles, wherein said freeze-thaw cycles optionally comprise freezing at −18° C. for 16 hours and thawing at 25° C. for 8 hours.

36. The starch blend according to claim 32, wherein the viscosity at eating temperature of said solution is at a level after four or five freeze-thaw cycles that is at the same or comparable to the viscosity after zero, one, two or three freeze-thaw cycles.

37. The starch blend according to claim 32, wherein:
the unmodified amylose containing starch is a native starch;
the unmodified amylose-containing starch contains from at least 10% to less than 50% amylose, at least about 15% to less than 50% amylose, or at least about 20% to less than 50% amylose, all by weight of the starch (w/w);
the unmodified amylose-containing starch is a native amylose-containing starch that contains from about 10% to less than 50% amylose, at least about 15% to less than 50% amylose, or at least about 20% to less than 50% amylose, all by weight of the starch (w/w); or
the unmodified amylose containing starch is a native amylose-containing potato starch that contains from about 10% to less than 50% amylose, at least about 15% to less than 50% amylose, or at least about 20% to less than 50% amylose, all by weight of the starch (w/w).

38. The starch blend according to claim 32, wherein the unmodified amylose containing starch is selected from potato, rice, tapioca, and corn.

39. The starch blend according to claim 32, wherein the non-chemically inhibited starch or non-chemically modified starch is a low amylose starch or a starch that contains less than 10% amylose, less than about 5%, less than about 2%, or less than about 1% amylose, all by weight of the starch (w/w).

40. The starch blend according to claim 32, wherein the non-chemically inhibited starch or non-chemically modified starch is selected from waxy corn, waxy tapioca, waxy rice, and waxy potato.

41. The starch blend according to claim 32, wherein the non-chemically inhibited starch or non-chemically modified starch is a thermally inhibited starch.

42. A method of preparing a composition, wherein said composition comprises one or more viscosifying agent, wherein said viscosifying agent comprises a starch blend according to any preceding claim and one or more other viscosifying agent, wherein said other viscosifying agent is at least partially replaced or replaced with 90% or less of the starch blend according to any preceding claim.

43. A composition comprising:
90-97% (w/w) of a fluid;
3-8% (w/w) of an inhibited amylose containing starch.

44. The composition of claim 43, wherein the fluid comprises a milk product or water.

45. The composition of claim 43, wherein the non-inhibited amylose containing starch or non-chemically modified starch is selected from waxy corn, waxy tapioca, waxy rice, and waxy potato.

46. The composition of claim 43, wherein the composition exhibits a smoother texture after cooling to approximately 2-7° C. for one week, compared to a composition without the non-inhibited modified starch.
